(19) United States
(12) Patent Application Publication
(10) Pub. No.: US 2025/0029764 A1
(43) Pub. Date: Jan. 23, 2025

(54) MAGNETIC COMPONENT ASSEMBLY AND MANUFACTURING METHOD THEREOF

(71) Applicant: Delta Electronics (Shanghai) Co., Ltd., Shanghai (CN)

(72) Inventors: Quanguang Chen, Shanghai (CN); Jinping Zhou, Shanghai (CN); Min Zhou, Shanghai (CN); Wen Han, Shanghai (CN); Ganyu Zhou, Shanghai (CN)

(21) Appl. No.: 18/643,852

(22) Filed: Apr. 23, 2024

(30) Foreign Application Priority Data
Jul. 20, 2023 (CN) 202310898011.5

(51) Int. Cl. H01F 27/00; H01F 41/00; H01F 41/02; H01F 41/10

(52) U.S. Cl. CPC H01F 27/006; H01F 41/005; H01F 41/0286; H01F 41/10

(57) ABSTRACT

A magnetic component assembly and a manufacturing method thereof are disclosed. The magnetic component assembly includes a magnetic component and a peripheral structure. The magnetic component includes a magnetic core and a winding. The winding is embedded in the magnetic core, and passes through the top surface or the bottom surface of the magnetic core to form a pin. The peripheral structure is disposed adjacent to a peripheral side of the magnetic core. The magnetic component and the peripheral structure are combined to form a magnetic assembling body. The manufacturing method thereof includes a step of thinning the top surface or the bottom surface of the magnetic assembling body through a thinning process. The manufacturing method thereof includes another step of thinning the top surface or the bottom surface of the magnetic core through a thinning process, or thinning the pin through the thinning process.

### CROSS-REFERENCE TO RELATED APPLICATION

This application claims priority to China Patent Application No. 202310898011.5, filed on Jul. 20, 2023. The entire contents of the above-mentioned patent application are incorporated herein by reference for all purposes.

### FIELD OF THE INVENTION

The present disclosure relates to a magnetic component assembly, and more particularly to a magnetic component assembly and a manufacturing method thereof.

### BACKGROUND OF THE INVENTION

With the development of intelligent equipment, the demand for data processing is increasing, and the high efficiency and the high-power density are important pointers in data processing.

The server is usually used in the conventional data center for data processing. The server includes the data processing chips, such as the central processing unit, the chip set and the internal memory, disposed on the main circuit board. In addition, the server further includes the power supply and the necessary components for the data processing chips disposed on the main circuit board. With the improvement of the processing capacity of the server, the number and integration of data processing chips are also increased simultaneously. As a result, the space in the server is almost occupied by data processing chips, and the power consumption of the server is also increased. Therefore, the power supply for the data processing chip needs to have higher efficiency and power density, and needs to have a smaller volume, so as to reduce the overall volume of the server and make the data center more energy-saving.

Taking the graphics processing unit (GPU) and voltage regulator module (VRM) disposed on the main circuit board as an example, as the power and the occupied area of the GPU are increased, the reserved area of the VRM is decreased. Therefore, the magnetic components contained in the VRM are vertically stacked with the power devices. In that, the power devices regarded as the largest heat source are arranged above the magnetic component and close to the heat sink to facilitate heat dissipation.

On the other hand, in order to meet the requirements of miniaturization and mass production manufacturing, the magnetic component is designed as the embedded magnetic component to form double-sided pins on the flat upper and lower surfaces, so as to facilitate the power device to be stacked on the main circuit board through the magnetic component. The conventional magnetic component assembly with the double-sided pins includes a magnetic core put in a frame and cooperated with a pressing operation, so as to obtain the magnetic component assembly with the double-side pins. In order to obtain a flat structure, a consistent height must be maintained between the magnetic core and the frame to facilitate the pressing operation. However, the inventor discovered that there is often a dimensional error of about 0.15 mm between the magnetic core and the frame. In case of that the height of the frame is lower than the height of the magnetic core, the magnetic core may have the risk of fracturing during the pressing operation. In case of that the height of the frame is higher than the height of the magnetic core, the risk of poor electroplating of blind vias is increased. At the same time, since the pins on the magnetic core are connected vertically up and down from both sides of the magnetic core, the connection path between the magnetic component and the power device will be longer and the loss will be greater.

Therefore, there is a need of providing a magnetic component assembly and a manufacturing method thereof, so as to form the magnetic component assembly with the embedded magnetic component meeting the requirements miniaturization and mass production manufacturing, reduce the impact of dimensional errors, and avoid the risk of poor electroplating in the subsequent embedded processes. At the same time, it can also reduce the connection path between the magnetic component and the power device, reduce the connection loss, improve the efficiency, and obviate the drawbacks encountered by the prior arts.

### SUMMARY OF THE INVENTION

An object of the present disclosure is to provide a magnetic component assembly and a manufacturing method thereof for forming the magnetic component assembly with the embedded magnetic component meeting the requirements miniaturization and mass production manufacturing. The spaced distance between the pins of the windings and thinned plane is controlled by thinning the magnetic assembling body for reducing the impact of dimensional errors, avoiding the risk of poor electroplating in subsequent embedded processes, and further improving the product yield.

Another object of the present disclosure is to provide a magnetic component assembly and a manufacturing method thereof. By thinning the magnetic core or the pins of the windings to minimize the tolerances of the magnetic core or the pins of the windings, the height difference between the pins of the windings and the peripheral structure is controlled to reduce the risk of poor electroplating in the other subsequent embedded processes. Thus, the product yield is improved.

A further object of the present disclosure is to provide a magnetic component assembly and a manufacturing method thereof. By leading out the pins of the winding through the upper and lower surfaces of the magnetic core, the connection path between the magnetic component and the power device is reduced, so that the connection loss is reduced, and the efficiency is improved. At the same time, the magnetic component allows integrate the signal pins and the power pins to improve the production efficiency.

In accordance with an aspect of the present disclosure, a manufacturing method of a magnetic component assembly is provided and includes steps of: (a) providing a peripheral structure; (b) providing a magnetic component, and assembling the magnetic component with the peripheral structure to form a magnetic assembling body, wherein the magnetic component includes a magnetic core and a winding, and the winding is embedded in the magnetic core and extended to the top surface or the bottom surface of the magnetic core to form a pin, wherein the peripheral structure is disposed adjacent to a peripheral side of the magnetic core;(c) laminating the magnetic assembling body; and (d) thinning the top surface of the magnetic assembling body to form a top thinned plane of the magnetic assembling body through a thinning process or thinning the bottom surface of the magnetic assembling body to form a bottom thinned plane of the magnetic assembling body through another thinning process.

In accordance with another aspect of the present disclosure, a manufacturing method of a magnetic component assembly is provided and includes steps of: (a) providing a magnetic component, wherein the magnetic component wherein the magnetic component includes a magnetic core and a winding, and the winding is embedded in the magnetic core and extended to the top surface or the bottom surface of the magnetic core to form a pin; (b) thinning the top surface or the bottom surface of the magnetic core through a thinning process, or thinning the pin through the thinning process; (c) providing a peripheral structure; and (d) combining the magnetic component and the peripheral structure to form a magnetic assembling body, wherein the peripheral structure is disposed adjacent to a peripheral side of the magnetic core.

In accordance with a further aspect of the present disclosure, a magnetic component assembly is provided and includes a magnetic component and a peripheral structure. The magnetic component includes a magnetic core and a winding. The winding is embedded in the magnetic core, and passes through the top surface or the bottom surface of the magnetic core to form a pin. The peripheral structure is disposed adjacent to a peripheral side of the magnetic core.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic cross-sectional view illustrating a magnetic component assembly according to a first embodiment of the present disclosure;

FIG. 2A and FIG. 2B are a perspective structural view and a cross-sectional view illustrating the magnetic component in the first embodiment of the present disclosure;

FIGS. 3A to 3F are schematic cross-sectional views illustrating a manufacturing method of a magnetic component assembly according to the first embodiment of the present disclosure;

FIGS. 3B′ and 3C′ are schematic cross-sectional views illustrating a partial manufacturing method of a magnetic component assembly according to the first embodiment of the present disclosure;

FIG. 4 is a schematic cross-sectional view illustrating a magnetic component assembly according to a second embodiment of the present disclosure;

FIG. 5A and FIG. 5B are a perspective structural view and a cross-sectional view illustrating the magnetic component in the second embodiment of the present disclosure;

FIGS. 6A to 6F are schematic cross-sectional views illustrating a manufacturing method of a magnetic component assembly according to the second embodiment of the present disclosure; and

FIGS. 6C′ and 6D′ are schematic cross-sectional views illustrating a partial manufacturing method of a magnetic component assembly according to the second embodiment of the present disclosure.

### DETAILED DESCRIPTION

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “upper,” “lower,” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “or” and the like may be used herein for including any or all combinations of one or more of the associated listed items. For example, “A or B”, which means “A” or “B” or “A and B”. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present disclosure and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

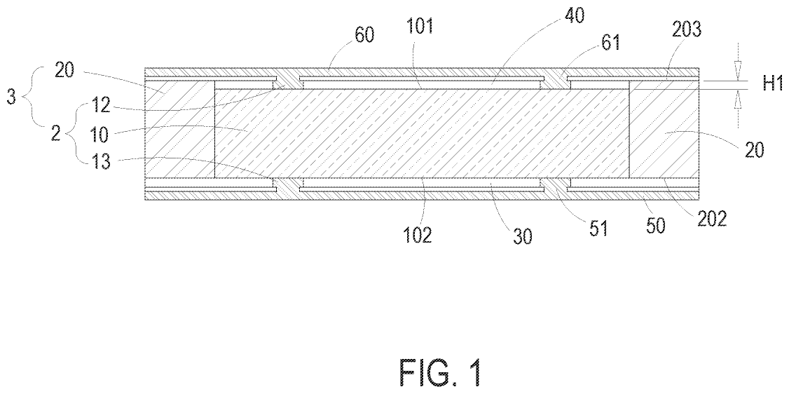

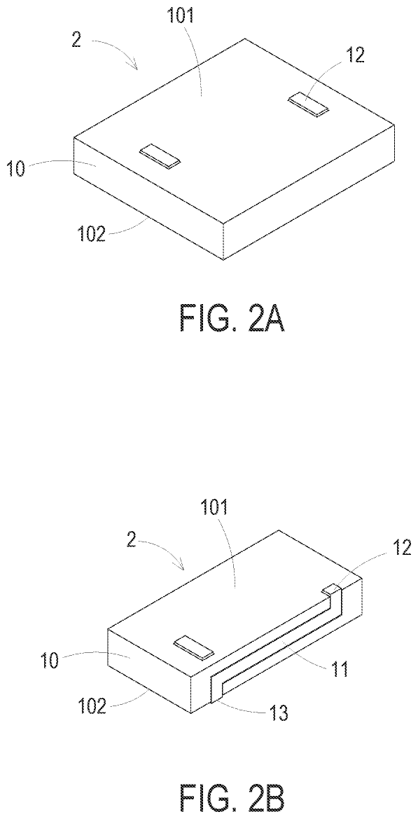

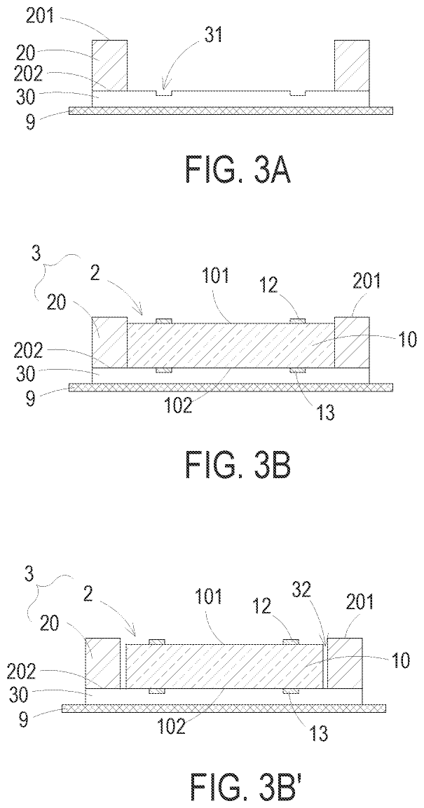

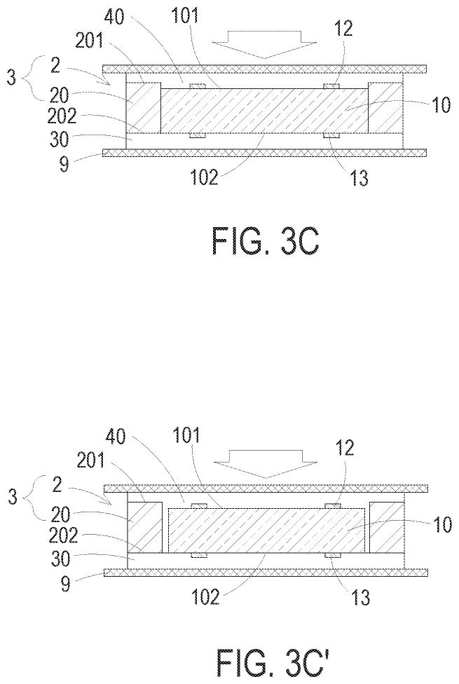

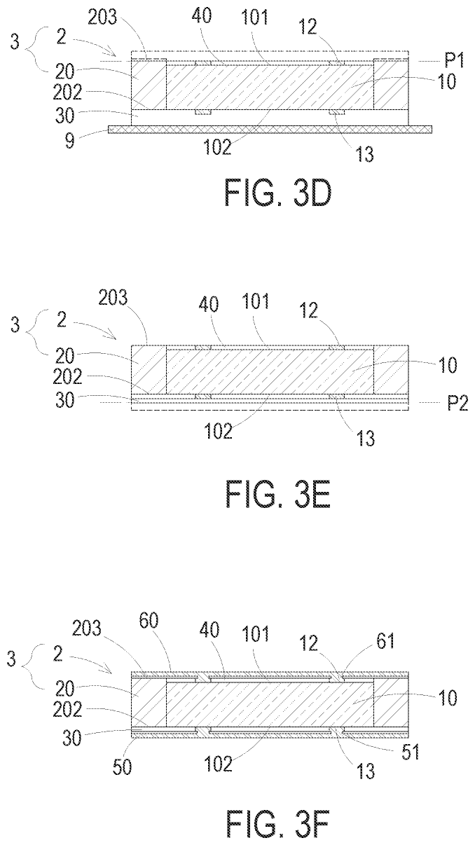

FIG. 1 is a schematic cross-sectional view illustrating a magnetic component assembly according to a first embodiment of the present disclosure. FIG. 2A and FIG. 2B are a perspective structural view and a cross-sectional view illustrating the magnetic component in the first embodiment of the present disclosure. FIGS. 3A to 3F are schematic cross-sectional views illustrating a manufacturing method of a magnetic component assembly according to the first embodiment of the present disclosure. FIGS. 3B′ and 3C′ are schematic cross-sectional views illustrating a partial manufacturing method of a magnetic component assembly according to the first embodiment of the present disclosure. In the embodiment, the magnetic component assembly 1 adopts the design of an embedded magnetic component for meeting the requirements of miniaturization and large-scale manufacturing. The magnetic component assembly 1 at least includes a magnetic component 2 and a peripheral structure 20. In the embodiment, the magnetic component 2 includes a magnetic core 10 and a winding 11. The winding 11 is embedded in the magnetic core 10, and passes through the top surface 101 and the bottom surface 102 of the magnetic core 10 to form pins 12, 13, respectively. In other embodiments of the present disclosure, the magnetic component 2 includes the pins led out through one single side of the structure. In some embodiments, the magnetic core 10 is made of the powder core material or the ferrite material. In some embodiments, the peripheral structure 20 is a frame or a plastic encapsulated structure formed by molding, and disposed adjacent to a peripheral side of the magnetic core 10 or arranged around the outer peripheral wall of the magnetic core 10. In some embodiments, the peripheral structure 20 is the frame, and the frame facilitates the integration of the magnetic component and the signal and power pins. In some embodiments, the material of the frame is a combination of the core board or the PP (Prepreg, also known as the adhesive film or the adhesive sheet) materials, and the plastic encapsulated structure is the epoxy molding compound. In the embodiment, the pins 12, 13 are protruded from the top surface 101 and the bottom surface 102 of the magnetic core 10 to be exposed outside the magnetic core 10. With the pins 12, 13 protruded from the magnetic core 10, when the height difference between the peripheral structure 20 and the pins 12, 13 needs to be reduced, it is not necessary to grind to the magnetic core 10, so that the inductance is not affected. Notably, the exposure of the pins 12, 13 refers to being protruded from the magnetic core 10, and an insulating layer can also be provided outside the magnetic core 10. In other embodiments of the present disclosure, the pins 12, 13 are coplanar with the top surface 101 and the bottom surface 102 of the magnetic core 10, respectively, or recessed from the top surface 101 and the bottom surface 102 of the magnetic core 10, respectively. In the embodiment, the top surface 201 of the peripheral structure 20 is further formed by a thinning process. In some embodiments, the magnetic component assembly 1 further includes a first interface material 30, and the bottom surface 202 of the peripheral structure 20 and the bottom surface 102 of the magnetic core 10 are disposed on the top surface of the first interface material 30. It allows to thin the thickness of the first interface material 30 disposed below the bottom surface 202 of the peripheral structure 20 and the bottom surface 102 of the magnetic core 10 through a thinning process. In some embodiments, the magnetic component assembly 1 further includes a second interface material 40, which is laminated on the top surface 101 of the magnetic core 10 and the top surface 201 of the peripheral structure 20. It allows to thin the top surface of the second interface material 40 through a thinning process to form a top thinned plane P1 of the magnetic component assembly 1, and the top thinned plane P1 is higher than the top surface 101 of the magnetic core 10. In some embodiments, a spaced distance H1 is formed between the top surface of the winding pin 12 on the tope surface 101 of the magnetic core 10 and the top thinned plane P1 (referring to FIG. 1 and FIG. 3D), and less than or equal to 0.08 mm. Notably, at present, the maximum plating capacity of blind via in the industry is 0.125 mm, and the interface material below the conductive layer is at least 0.045 mm. Therefore, the top thinned plane P1 is at most 0.08 mm higher than the top surface of the pin 12 on the top surface 101 of the magnetic core 10. In other embodiments of the present disclosure, when the pin 12 is protruded from the second interface material 40, the thinning process is used to thin the pin 12 of the winding 11 merely. At this time, the top thinned plane P1 is coplanar with the top surface of the pin 12 on the top surface 101 of the magnetic core 10. In some embodiments of the present disclosure, when the top surface 201 of the peripheral structure 20 is higher than the top surface 101 of the magnetic core 10, both of the top surface 201 of the peripheral structure 20 and the second interface material 40 are simultaneously thinned through the thinning process to form the top thinned plane P1 of the magnetic component assembly 1. That is, the top thinned plane P1 is formed by thinning the pin 12 on the top surface 101 of the magnetic core 10, by thinning the second interface material 40 merely, or by thinning both of the second interface material 40 and the top surface 201 of the peripheral structure 20. Similarly, it allows to thin the bottom surface of the first interface material 30 through a thinning process to form a bottom thinned plane P2 of the magnetic component assembly 1, and the bottom thinned plane P2 is lower than the bottom surface 102 of the magnetic core 10. In some embodiments, a spaced distance is formed between the bottom surface of the winding pin 13 on the bottom surface 102 of the magnetic core 10 and the top thinned plane P2, and less than or equal to 0.08 mm. At present, the maximum plating capacity of blind via in the industry is 0.125 mm, and the interface material below the conductive layer is at least 0.045 mm. Therefore, the bottom thinned plane P2 is at most 0.08 mm lower than the bottom surface of the pin 13 on the bottom surface 102 of the magnetic core 10. Similar to the formation of the top thinned plane P1, in some embodiments of the present disclosure, the bottom thinned plane P2 is formed by thinning the pin 13 on the bottom surface 102 of the magnetic core 10, by thinning the first interface material 30 merely, or by thinning both of the first interface material 30 and the bottom surface 202 of the peripheral structure 20. In some embodiments, the first interface material 30 and the second interface material 40 are insulating materials, such as the PP (Prepreg, also known as the adhesive film or the adhesive sheet) materials. In some embodiments, in the embodiment, the magnetic component assembly 1 further includes a conductive layer 60 disposed on the top thinned plane P1. The conductive layer 60 is electrically connected to the pin 12 on the top surface 101 of the magnetic core 10 through a blind via 61. In some embodiments, the conductive layer 60 is a copper layer. Similarly, in the embodiment, the magnetic component assembly 1 further includes a conductive layer 50, and the conductive layer 50 is disposed on the bottom surface of the first interface material 30. The conductive layer 50 is electrically connected to the pin 13 on the bottom surface 102 of the magnetic core 10 through a blind via 51. In some embodiments, the conductive layer 50 is a copper layer. In some embodiments, the top surface 101 or the bottom surface 102 of the magnetic core 10 is produced through a thinning process. In some embodiments of the present disclosure, the thinning process is a grinding process or a plasma thinning process. In this way, it allows to stack the magnetic component assembly 1 between the main circuit board (not shown) and the power device (not shown) to achieve the application of voltage regulator module.

Since the average dimensional error of the magnetic core 10 of the magnetic component 2 in the mass production process is about 0.1 mm, and the average dimensional error of the peripheral structure 20 in the mass production process is about ±0.05 mm, when the magnetic component 2 and the peripheral structure 20 are assembled and arranged adjacent to each other, and the bottom surface 202 of the peripheral structure 20 is coplanar with the bottom surface 102 of the magnetic core 10, a spaced distance formed between the top surface 101 of the magnetic core 10 and the top surface 201 of the peripheral structure 20 may reach 0.15 mm. However, by utilizing the following manufacturing method of the present disclosure, when the peripheral structure 20 is assembled with the magnetic core 10, it ensures that the top surface 201 of the peripheral structure 20 is higher than the top surface 101 of the magnetic core 10, and the spaced distance H1 formed between the pins 12, 13 of the winding 11 and the thinned plane P1, P2 is within a specific range. In this way, the height difference between the surface of the pins 12, 13 and the conductive layer is reduced in other embedded processes to avoid poor electroplating, and further reduce the connection path between the magnetic component assembly and the power device. Thus, the connection loss is reduced and the efficiency is improved. The manufacturing method of the magnetic component assembly 1 will be described as follows.

In the embodiment, a magnetic component 2 and a peripheral structure 20 are provided. In some embodiments, the magnetic component 2 is a transformer, an integrally formed inductor or an assembled inductor. In the embodiment, the magnetic component 2 is an inductor with double-sided pins. The magnetic component 2 includes a magnetic core 10 and a winding 11. The winding 11 is embedded in the magnetic core 10 and extended to the top surface 101 and the bottom surface 102 of the magnetic core 10 to form pins 12, 13, respectively. In some embodiments, the pins 12, 13 of the winding 11 are lower than the peripheral structure 20, higher than the peripheral structure 20, or coplanar with the peripheral structure 20. In the other embodiments of the present disclosure, the winding 11 is led out to form the pins on one of the top surface 101 and the bottom surface 102 of the magnetic core 10 merely. Thereafter, the magnetic component 2 and the peripheral structure 20 are assembled to form a magnetic assembling body 3. Then, a lamination process is performed on the magnetic assembling body 3 formed by the magnetic component 2 and the peripheral structure 20. When performing the lamination process, it can be laminated once or multiple times. In some embodiments, the laminating direction is perpendicular to the top surface of the magnetic assembling body 3. In some embodiments, the peripheral structure 20 is a frame or a plastic encapsulated structure formed by molding. Taking the frame as an example, the frame is composed of a core board and the PP material. Firstly, slots are made in the core board and the PP material, then the core board and the PP material are stacked, and the magnetic component 2 is placed in the slots. When performing the lamination process, the PP material is allowed to flow into the gap 32 formed between the magnetic component 2 and the peripheral structure 20, as shown in FIG. 3C and FIG. 3C′. Thereafter, the top surface of the magnetic assembling body 3 is thinned to form a top thinned plane P1 through the thinning process, or the bottom surface of the magnetic assembling body 3 is thinned to form a bottom thinned plane P2 through the thinning process. It should be noted that, in some embodiments, only the top surface of the magnetic assembling body 3 is thinned to form a top thinned plane P1 through the thinning process. In some other embodiments, only the bottom surface of the magnetic assembling body 3 is thinned to form a bottom thinned plane P2 through the thinning process. In some other embodiments, both the top surface and the bottom surface of the magnetic assembling body 3 is thinned to form a top thinned plane P1 and a bottom thinned plane P2 through the thinning process, respectively. In some embodiments of the present disclosure, the space distance H1 formed between the top thinned plane P1 and the pin 12 of the winding 11 is less than or equal to 0.08 mm. The space distance H1 formed between the bottom thinned plane P2 and the pin 13 of the winding 11 is less than or equal to 0.08 mm. In some embodiments of the present disclosure, before performing the lamination process, a first interface material 30 is added on the bottom surface of the magnetic assembling body 3, or a second interface material 40 is added on the top surface of the magnetic assembling body 3. The first interface material 30 and the second interface material 40 are used to void the material shortage between the magnetic component 2 and the peripheral structure 20 after lamination, and increase the reliability. It allows to reduce the spaced distance H1 formed between the top thinned plane P1 and the pin 12 of the winding 11 through the thinning process, or reduce the spaced distance H1 formed between the bottom thinned plane P2 and the pin 13 of the winding 11 through the thinning process. In some embodiments, the thinning process is a grinding process or a plasma thinning process. When the top surface 201 of the peripheral structure 20 is lower than the top surface of the magnetic component 2, it allows to thin the top surface of the magnetic component 2 to reduce the spaced distance H1 formed between the top thinned plane P1 and the pin 12 of the winding 11, or reduce the spaced distance H1 formed between the bottom thinned plane P2 and the pin 13 of the winding 11, so as to reduce the height of the magnetic component assembly 1. If the pins 12, 13 are protruded from the magnetic core 10, it allows to thin the pins 12, 13 merely, or thin both of the pins 12, 13 and the magnetic core 10, so as to reduce the height of the magnetic component assembly 1. If the pins 12, 13 are recessed from the top surface 101 or the bottom surface 102 of the magnetic core 10, it allows to thin the magnetic core 10 merely, or thin both of the magnetic core 10 and the pins 12, 13. When the pins 12, 13 are protruded from the peripheral structure 20, it allows to embed the pins 12, 13 into the carrying board or the interface material. Therefore, the carrying board or the interface material includes a recess 31 or a through hole disposed thereon for fitting with the protruded pins 12, 13, as shown in FIG. 3A and FIG. 3B. It helps to prevent the magnetic component 2 from being skewed when the magnetic component 2 is placed. Moreover, the damage to the carrying board or the interface material or the material shortage is avoided. When the peripheral structure 20 is higher than the pins 12, 13, it allows to reduce the spaced distance H1 formed between the top thinned plane P1 and the pin 12 of the winding 11, or reduce the spaced distance H1 formed between the bottom thinned plane P2 and the pin 13 of the winding 11 through the thinning process, so that the height of the blind via is reduced and the defect rate of blind vias during electroplating is reduced. Similarly, it allows to thin the magnetic core 10 through the thinning process, so as to reduce the defect rate of blind vias during electroplating and reduce the height of the magnetic component assembly 1. In some embodiments, the blind vias are produced by laser drilling, mechanical drilling and slotting. In some embodiments of the present disclosure, the magnetic component assembly 1 further includes a conductive layer 60 disposed on the top thinned plane P1. The conductive layer 60 is electrically connected to the pin 12 on the top surface 101 of the magnetic core 10 through a blind via 61. In some embodiments, the conductive layer 60 is a copper layer. Similarly, the magnetic component assembly 1 further includes a conductive layer 50 disposed on the bottom surface of the bottom thinned plane P2. The conductive layer 50 is electrically connected to the pin 13 on the bottom surface 102 of the magnetic core 10 through a blind via 51. In some embodiments, the conductive layer 50 is a copper layer.

Please refer to FIG. 3A and FIG. 3B. In the embodiment, the bottom surface of the magnetic assembling body 3 is disposed on the top surface of the first interface material 30. In the embodiment, the bottom surface 202 of the peripheral structure 20 and the bottom surface 102 of the magnetic core 10 are coplanar on the first interface material 30. In some embodiments, the top surface 201 of the peripheral structure 20 is higher than the top surface 101 of the magnetic core 10. When the lamination process is performed on the top surface or the bottom surface of the magnetic assembling body 3, it allows to laminate the first interface material 30 with the magnetic assembling body 3. In the embodiment, the bottom surface of the first interface material 30 is disposed on the carrying board 9 to carry out the subsequent mass production processes, as shown in FIG. 3A and FIG. 3B. In other embodiments, a plural sets of the first interface materials 30 and the peripheral structures 20 are placed on the carrying board 9. In the embodiment, the magnetic component 2 is an inductor with double-sided pins, as shown in FIG. 2A and FIG. 2B. The magnetic component 2 includes a magnetic core 10 and a winding 11. The winding 11 is embedded in the magnetic core 10 and electrically connected to the top surface 101 and the bottom surface 102 of the magnetic core 10 to form the upper pin 12 and the lower pin 13 thereon, respectively. In the embodiment, the pin 12 is protruded from the top surface 101 of the magnetic core 10 to be exposed, and the pin 13 is protruded from the bottom surface 102 of the magnetic core 10 to be exposed. In other embodiments, the magnetic component 2 includes at least one pin exposed through the top surface 101 or the bottom surface 102 of the magnetic core 10. In the embodiment, the magnetic component 2 and the peripheral structure 20 on the first interface material 30 are assembled on the top surface of the first interface material 30. The peripheral structure 20 is disposed adjacent to a peripheral side of the magnetic core 10. In some embodiments, the bottom surface 202 of the peripheral structure 20 and the bottom surface 102 of the magnetic core 10 are coplanar on the top surface of the first interface material 30, and the pin 13 under the magnetic component 2 is embedded into the first interface material 30. In some embodiments, the top surface 201 of the peripheral structure 20 is higher than the top surface 101 of the magnetic core 10, for example 0.15 mm.

In some embodiments, a second interface material 40 is laminated on the top surface 201 of the peripheral structure 20 and the top surface 101 of the magnetic core 10, as shown in FIG. 3C. The bottom surface of the second interface material 40 is attached to the top surface 201 of the peripheral structure 20 and the top surface 101 of the magnetic core 10. By laminating the first interface material 30 and the second interface material 40 thereon, a part of the first interface material 30 or the second interface material 40 can be used to fill the gap 32 formed between the magnetic component 2 and the peripheral structure 20 to fix the position of the magnetic component 2. Thereafter, the thinning process is performed to thin the top surface of the second interface material 40 downwards, and the end point of the thinning process can be set between the top surface 201 of the peripheral structure 20 and the top surface 101 of the magnetic core 10. In some embodiments, the at least one pin is exposed after the thinning process. For example, the pin 13 is protruded from the bottom surface 102 of the magnetic core 10 and exposed through the bottom thinned plane P2, or the pin 12 is protruded from the top surface 101 of the magnetic core 10 and exposed through the top thinned plane P1. In some embodiments of the present disclosure, the pins 12, 13 are coplanar with the top surface 101 and the bottom surface 102 of the magnetic core 10. Since the top surface 201 of the peripheral structure 20 is higher than the top surface 101 of the magnetic core 10, the second interface material 40 is partially removed, or both of the second interface material 40 and the top surface of the magnetic assembling body 3 are partially removed through the thinning process, so as to form the top thinned plane P1 of the magnetic component assembly 1, as shown in FIG. 3D. In the embodiment, the top thinned plane P1 and the top surface of the pin 12 on the top surface 101 of the magnetic core 10 have a spaced distance H1. In some embodiments, the spaced distance H1 is controlled to be less than or equal to 0.08 mm. In the embodiment shown in FIG. 3D, the spaced distance H1 is equal to 0. That is, the top thinned plane P1 and the top surface of the pin 12 on the top surface 101 of the magnetic core 10 are coplanar. In other embodiments, the end point for thinning the second interface material 40 and the top surface 201 of the peripheral structure 20 is adjustable according to the practical requirements, so that the spaced distance H1 between the top thinned plane P1 and the pin 12 on the top surface 101 of the magnetic core 10 is effectively controlled.

On the other hand, it allows the lower first interface material 30 to be turned upside down to perform a similar thinning process, so that the bottom surface of the first interface material 30 is thinned to form the bottom thinned plane P2 of the magnetic component assembly 1, as shown in FIG. 3E. In an embodiment, both of first interface material 30 and the bottom surface of the magnetic assembling body 3 are thinned at the same time to form the bottom thinned plane P2. In an embodiment, the first interface material 30 is thinned to expose the lower pin 13. Moreover, the thinning process for thing the first interface material 30 is adjustable according to the practical requirements, to facilitate to carry out the subsequent embedded processes. In some embodiments, in the embodiment, the spaced distance H1 between the bottom thinned plane P2 and the pin 13 on the bottom surface 102 of the magnetic core 10 is less than or equal to 0.08 mm after the thinning process. In other embodiments, the first interface material 30 is completely removed to expose the lower pin 13.

Notably, by performing the above thinning process, the spaced distance H1 between the top thinned plane P1 and the pin 12 of the winding 11, or the space distance H1 between the bottom thinned plane P2 and the pin 13 of the winding 11 is reduced. In some embodiment, the spaced distance H1 between the top thinned plane P1 and the top surface of the pin 12 on the top surface 101 of the magnetic core 10 is less than or equal to 0.08 mm, the spaced distance H1 between the bottom thinned plane P2 and the bottom surface of the pin 13 on the bottom surface 102 of the magnetic core 10 is less than or equal to 0.08 mm, and the pins 12, 13 are respectively exposed through the top thinned plane P1 and the bottom thinned plane P2. Thereafter, in other embedded processes, a conductive layer 60 is formed on the top thinned plane P1, and the conductive layer 60 is electrically connected to the pin 12 protruded from the top surface 101 of the magnetic core 10 through the blind via 61. In some embodiments, the conductive layer 60 is a copper layer, as shown in FIG. 3F. In other embodiments, the pin 12 is not exposed after the thinning process, and the conductive layer 60 formed on the top thinned plane P1 is electrically connected to the pin 12 protruded from the top surface 101 of the magnetic core 10 through the blind via 61 passing through the second interface material 40. Similarly, after the first interface material 30 is thinned to form the bottom thinned plane P2, a conductive layer 50 is formed on the bottom thinned plane P2. In some embodiments, the conductive layer 50 is a copper layer. The conductive layer 50 is electrically connected to the pin 13 protruded from the bottom surface 102 of the magnetic core 10 through the blind via 51. In other embodiments, the pin 13 is not exposed after the thinning process, and the conductive layer 50 formed on the bottom thinned plane P2 is electrically connected to the pin 13 protruded from the bottom surface 102 of the magnetic core 10 through the blind via 51 passing through the first interface material 30. In some other embodiments, the magnetic component assembly 1 is produced through the other embedded processes to connect the pin 12 of the magnetic core 10 with the conductive layer 60 or connected the pin 13 of the magnetic core 10 with the conductive layer 50, so that the DC resistance (DCR) of the magnetic component assembly 1 is optimized. Certainly, the present disclosure is not limited thereto and not redundantly described herein.

Notably, in other embodiments, in the producing process of the magnetic component assembly 1, the top surface 201 of the peripheral structure 20 is not lower than the top surface 101 of the magnetic core 10. In that, when the second interface material 40 is laminated, the risk of fracturing the magnetic component 2 is avoided during the lamination operation. Furthermore, the spaced distance H1 between the top thinned plane P1 and the pin 12 of the winding 11, or the space distance H1 between the bottom thinned plane P2 and the pin 13 of the winding 11 is reduced through the thinning process. When the conductive layer 60 and the pin 12 on the top thinned plane P1 need to be electrically connected through the blind via 61, there is no need to carry out a long-distance blind via operation. It facilitates to reduce the distance from the surface of the pin 12 to the conductive layer 60, and the defect rate of blind vias during electroplating is reduced effectively. In other embodiments, the pins 12, 13 of the magnetic component 2 are further protruded and pass through the second interface material 40 or the first interface material 30 to be exposed. In this way, the foregoing blind vias 51, 61 are omitted, and the DC resistance (DCR) of the magnetic component assembly 1 is minimized.

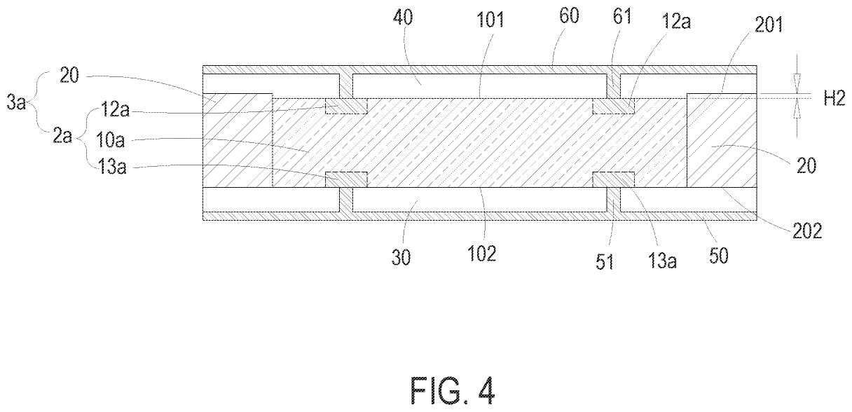

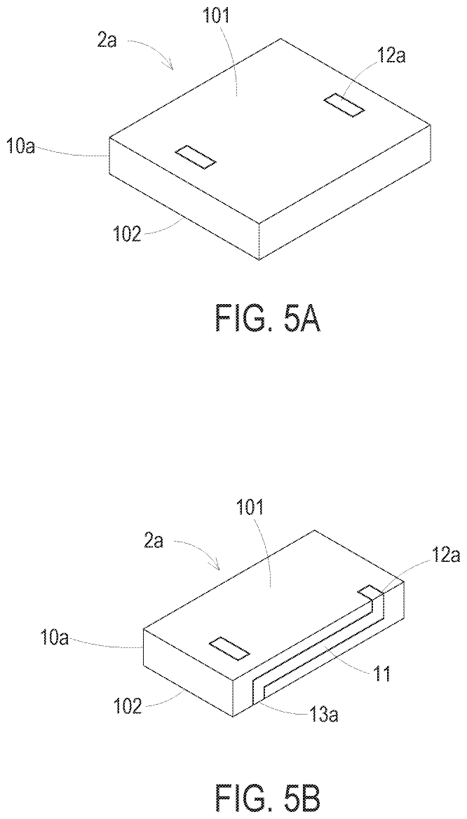

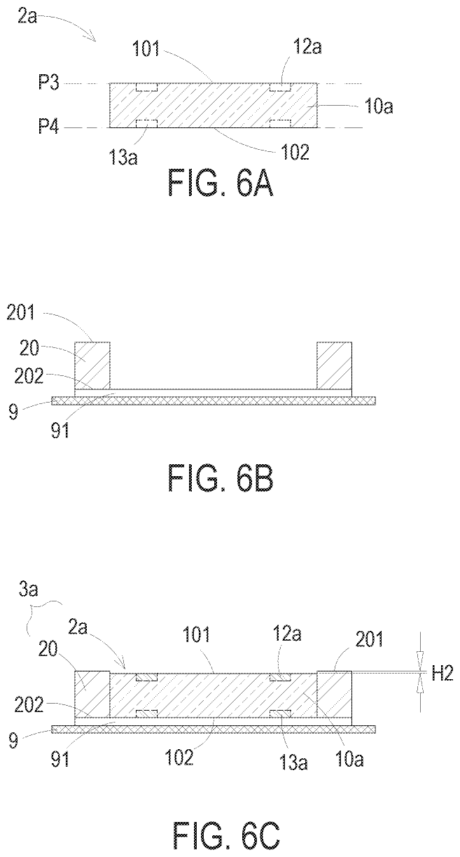

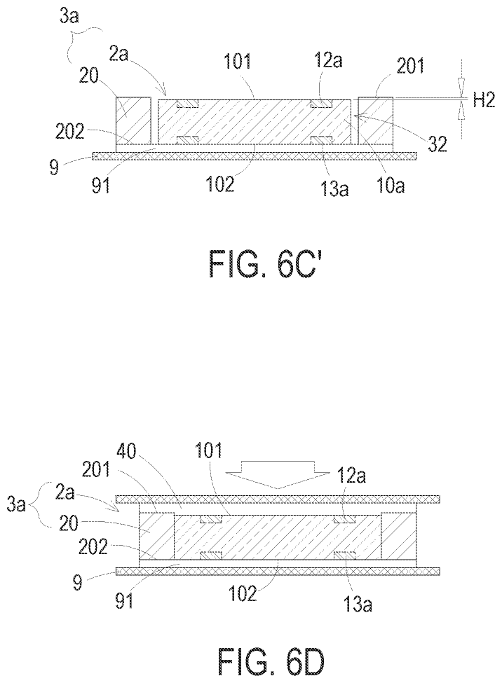

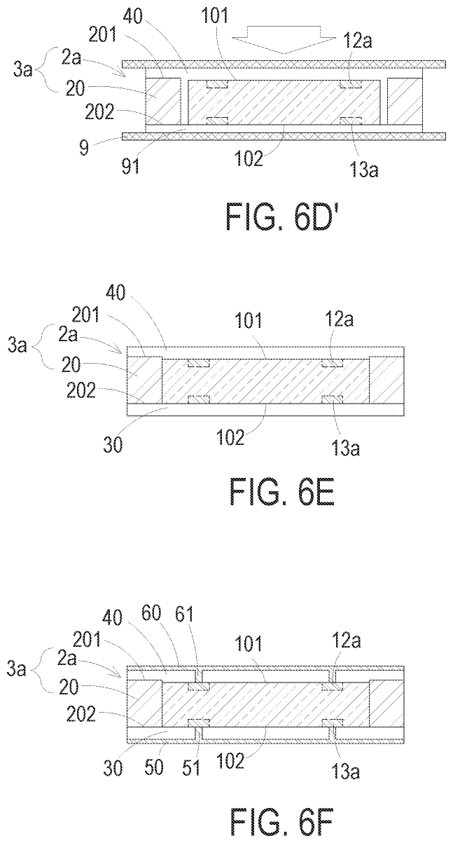

FIG. 4 is a schematic cross-sectional view illustrating a magnetic component assembly according to a second embodiment of the present disclosure. FIG. 5A and FIG. 5B are a perspective structural view and a cross-sectional view illustrating the magnetic component in the second embodiment of the present disclosure. FIGS. 6A to 6F are schematic cross-sectional views illustrating a manufacturing method of a magnetic component assembly according to the second embodiment of the present disclosure. FIGS. 6C′ and 6D′ are schematic cross-sectional views illustrating a partial manufacturing method of a magnetic component assembly according to the second embodiment of the present disclosure. In the embodiment, the magnetic component assembly 1a adopts the design of an embedded magnetic component for meeting the requirements of miniaturization and large-scale manufacturing. The magnetic component assembly 1a at least includes a magnetic component 2a and a peripheral structure 20. In the embodiment, the magnetic component 2a is an inductor with one-sided pins or double-sided pins, and includes a magnetic core 10a and a winding 11. The winding 11 is embedded in the magnetic core 10a, and passes through the top surface 101 and the bottom surface 102 of the magnetic core 10a to form at least one pin 12a or at least one pin 13a, respectively. In the embodiment, the peripheral structure 20 is a frame or a plastic encapsulated structure formed by molding, and disposed adjacent to a peripheral side of the magnetic core 10a or arranged around the outer peripheral wall of the magnetic core 10a. In the embodiment, the bottom surface 202 of the peripheral structure 20 and the bottom surface 102 of the magnetic core 10a are coplanar for assembling. In some embodiments, the top surface 201 of the peripheral structure 20 is higher than the top surface 101 of the magnetic core 10a, a height difference H2 formed between the top surface 201 of the peripheral structure 20 and the pin 12a on the top surface 101 of the magnetic core 10a is less than or equal to 0.08 mm. Furthermore, when the pins 12a, 13a are protruded from the top surface 101 and the bottom surface 102 of the magnetic core 10a to be exposed, the top surface of the pin 12a on the top surface 101 of the magnetic core 10a and the bottom surface of the pin 13a on the bottom surface 102 of the magnetic core 10a are produced through the thinning process. In this way, when the height difference H2 between the peripheral structure 20 and the winding pins 12a, 13a needs to be reduced, only the pins 12a, 13a of the winding 11 are thinned without thinning the magnetic core 10a, so that the inductance of the magnetic component assembly 1a is not affected. When the pins 12a, 13a are not protruded from the top surface 101 or the bottom surface 102 of the magnetic core 10a, it allows to thin the top surface 101 or the bottom surface 102 of the magnetic core 10a through the thinning process. Notably, in the embodiment, the height difference H2 is the spaced distance between the pin 12 on the top surface 101 of the magnetic core 10a and the top surface 201 of the peripheral structure 20, or the spaced distance between the pin 13 on the bottom surface 102 of the magnetic core 10a and the bottom surface 202 of the peripheral structure 20. In some embodiments, the bottom surface 202 of the peripheral structure 20 and the bottom surface 102 of the magnetic core 10a are coplanar, and the pin 12a on the top surface 101 of the magnetic core 10a and the top surface 201 of the peripheral structure 20 have a height difference H2. That is, the pin 12a on the top surface 101 of the magnetic core 10a can be higher than, equal to or lower than the top surface 201 of the peripheral structure 20. Moreover, the height difference H2 of the pin 12a on the top surface 101 of the magnetic core 10a and the top surface 201 of the peripheral structure 20 is less than or equal to 0.08 mm. Similarly, the pin 13a on the bottom surface 102 of the magnetic core 10a can be higher than, equal to or lower than the bottom surface 202 of the peripheral structure 20. Moreover, the height difference H2 of the pin 13a on the bottom surface 102 of the magnetic core 10a and the bottom surface 202 of the peripheral structure 20 is less than or equal to 0.08 mm. In other embodiments of the present disclosure, the bottom surface 202 of the peripheral structure 20 is higher or lower than the bottom surface 102 of the magnetic core 10a. In the embodiment, the uppermost conductive layer 60 is electrically connected to the pin 12a of the magnetic component 2a through a blind via 61, and the lowermost conductive layer 50 is electrically connected to the pin 13a of the magnetic component 2a through a blind via 51. In other embodiments of the present disclosure, the conductive layer 50, 60 are the surface copper. In this way, it allows to stack the magnetic component assembly 1a between the main circuit board (not shown) and the power device (not shown) to achieve the application of voltage regulator module.

Notably, in the embodiment, the top surface 101 or the bottom surface 102 of the magnetic core 10a can be further produced through the thinning process. In other embodiments of the present disclosure, when the pins 12a, 13a are protruded respectively from the top surface 101 and the bottom surface 102 of the magnetic core 10a, it allows to form the top surface of the pins 12a on the top surface 101 of the magnetic core 10a and form the bottom surface of the pins 13a on the bottom surface 102 of the magnetic core 10a through the thinning process. When the magnetic component 2a and the peripheral structure 20 are assembled and arranged adjacent to each other to form the magnetic assembling body 3a, the height difference H2 formed between the top surface 101 of the magnetic core 10a and the top surface 201 of the peripheral structure 20 is controlled to be less than or equal to 0.08 mm. Moreover, the height difference H2 formed between the pin 13 on the bottom surface 102 of the magnetic core 10a and the bottom surface 202 of the peripheral structure 20 is controlled to be less than or equal to 0.08 mm. It helps to reduce the risks of poor electroplating in the other subsequent embedded processes or fracturing the inductor. Consequently, the product yield is improved. The manufacturing method of the magnetic component assembly 1a will be described as follows.

In the embodiment, a magnetic component 2a is provided. In some embodiments, the magnetic component 2a is a transformer, an integrally formed inductor or an assembled inductor. In the embodiment, the magnetic component 2a is an inductor with double-sided pins, as shown in FIG. 5A and FIG. 5B. The magnetic component 2a includes a magnetic core 10a and a winding 11. The winding 11 is embedded in the magnetic core 10a and extended to the top surface 101 and the bottom surface 102 of the magnetic core 10a to form pins 12a, 13a, respectively. Then, a thinning process is performed to thin the magnetic core 10a or the pins 12a, 13a, and a top thinned plane P3 and a bottom thinned plane P4 of the magnetic core 10a are formed and served as the top surface 101 and the bottom surface 102 of the magnetic core 10a, as shown in FIG. 6A and FIG. 6C. In this way, when the magnetic core 10a of the magnetic component 2a is produced in mass production, it ensures that the height difference H2 between the top surface 101 of the magnetic core 10a and the top surface 201 of the peripheral structure 20, and the height difference H2 between the pin 13a on the bottom surface 102 of the magnetic core 10a and the bottom surface 202 of the peripheral structure 20 are less than or equal to 0.08 mm, to facilitate to carry out the subsequent embedded processes. In the embodiment, the winding 11 embedded in the magnetic core 10a is produced through the thinning process to form the upper pin 12a exposed on the top surface 101 of the magnetic core 10a and form the lower pin 13a exposed on the bottom surface 102 of the magnetic core 10a. In some embodiments, the pins 12a, 13a are not protruded from the top surface 101 and the bottom surface 102. In an embodiment, the pin 12a and the pin 13a are protruded from the top surface 101 and the bottom surface 102, respectively. In other embodiments, the types of the pin 12a and the pin 13a are adjustable according to the practical requirements.

Thereafter, a peripheral structure 20 is provided. In some embodiments, the peripheral structure 20 is a frame or a plastic encapsulated structure formed by molding. In an embodiment, the peripheral structure 20 is disposed on a carrying board 9 through an insulating layer 91, as shown in FIG. 6B, so as to facilitate to carry out the subsequent processes in mass production. In some embodiments of the present disclosure, the insulating layer 91 is an adhesive type. Certainly, the present disclosure is not limited to the manner in which the peripheral structure 20 is disposed on the carrying board 9. Then, as shown in FIG. 6C, the magnetic component 2a and the peripheral structure 20 are combined on the carrying board 9 to form the magnetic assembling body 3a. The bottom surface of the magnetic assembling body 3a is disposed on the carrying board 9. The peripheral structure 20 is disposed adjacent to a peripheral side of the magnetic core 10a, the bottom surface 202 of peripheral structure 20 and the bottom surface 102 of the magnetic core 10a are attached to the insulating layer 91, and are coplanar on the carrying board 9. Notably, when the grinded magnetic core 10 and the peripheral structure 20 are assembled, a height difference H2 is maintained between the top surface 201 of the peripheral structure 20 and the pin 12a on top surface 101 of the magnetic core 10a, and the height difference H2 is less than or equal to 0.08 mm. In some embodiments, the top surface 201 of the peripheral structure 20 is higher than the pin 12a on the top surface 101 of the magnetic core 10a. Furthermore, the height difference H2 between the pin 13a of the winding 11 on the bottom surface 102 of the magnetic core 10a and the bottom surface 202 of the peripheral structure 20 is less than or equal to 0.08 mm.

In the embodiment, the magnetic component 2a and the peripheral structure 20 are assembled together to form the magnetic assembling body 3a. In some embodiments, the magnetic component 2a and the peripheral structure 20 are laminated to form the magnetic assembling body 3a. In the lamination process, it can be laminated once or multiple times. In some embodiments, the lamination direction is perpendicular to the top surface of the magnetic assembling body 3a. In some embodiments, the peripheral structure 20 is a frame or a plastic encapsulated structure formed by molding. Taking the frame as an example, the frame is composed of a core board and the PP material. Firstly, slots are made in the core board and the PP material, then the core board and the PP material are stacked, and the magnetic component 2a is placed in the slots. When performing the lamination process, the PP material is allowed to flow into the gap 32 formed between the magnetic component 2a and the peripheral structure 20, as shown in FIG. 6C′ and FIG. 6D′. Please refer to FIG. 6C and FIG. 6D. In some embodiments of the present disclosure, a second interface material 40 is added on the top surface of the magnetic assembling body 3a before lamination. With the second interface material 40, it facilitates to void the material shortage between the magnetic component 2a and the peripheral structure 20 after lamination, and increase the reliability. The bottom surface of the second interface material 40 is attached to the top surface 201 of the peripheral structure 20 and the top surface 101 of the magnetic core 10a. In other embodiments, in the producing process of the magnetic component assembly 1a, the top surface 201 of the peripheral structure 20 is not lower than the top surface 101 of the magnetic core 10a. In that, when the second interface material 40 is laminated, the risk of fracturing the magnetic component 2a is avoided during the lamination operation. Furthermore, it allows to thin the top surface 101 and the bottom surface 102 of the magnetic core 10a or the corresponding pins 12a, 13a of the magnetic component 2a through the thinning process. In that, the height difference H2 formed between the top surface 101 of the magnetic core 10a and the top surface 201 of the peripheral structure 20 is controlled to be less than or equal to 0.08 mm, or the height difference H2 formed between the pin 13 on the bottom surface 102 of the magnetic core 10a and the bottom surface 202 of the peripheral structure 20 is controlled to be less than or equal to 0.08 mm. It helps to maintain the consistency in lamination operation, reduce the risks of poor electroplating in the other subsequent embedded processes or fracturing the inductor. Consequently, the product yield is improved. In some embodiments of the present disclosure, the thinning process is a grinding process or a plasma thinning process.

On the other hand, the foregoing structure is removed from the carrying board 9 and the insulating layer 91, and turned upside down to perform a similar lamination process. The first interface material 30 is laminated on the bottom surface 202 of the peripheral structure 20 and the bottom surface 102 of the magnetic core 10a, as shown in FIG. 6E. Since the bottom surface 202 of the peripheral structure 20 and the bottom surface 102 of the magnetic core 10a are maintained to be coplanar, it helps to maintain the consistency in lamination operation, reduce the risks of poor electroplating in the other subsequent embedded processes or fracturing the inductor. In other embodiments, the bottom surface of the first interface material 30 is disposed on the carrying board 9. When the lamination process is performed on the top surface or the bottom surface of the magnetic assembling body 3a, it allows to laminate the first interface material 30 with the magnetic assembling body 3a. In other embodiments, a plural sets of the first interface materials 30 and the peripheral structures 20 are placed on the carrying board 9.

In the embodiment, after the first interface material 30 and the second interface material 40 are laminated on the structure, a blind via 51 is further formed in the first interface material 30, or a blind via 61 is further formed in the second interface material 40. The lower blind via 51 in the first interface material 30 is spatially corresponding to the pin 13a on the bottom surface 102 of the magnetic core 10a, and the upper blind via 61 in the second interface material 40 is spatially corresponding to the pin 12a on the top surface 101 of the magnetic core 10a. The obtained structure is shown in FIG. 6F. In some embodiments, the first interface material 30 or the second interface material 40 is the insulating material.

Furthermore, in the embodiment, the conductive layer 50 is formed on the bottom surface of the first interface material 30, and the conductive layer 60 is formed on the top surface of the second interface material 40. In some embodiments, the conductive layers 50, 60 are the surface copper. In an embodiment, the interface materials are disposed on the surfaces of the magnetic assembling body 3a but not performed the lamination operation to laminate the interface materials with the magnetic assembling body 3a. After the conducive layers are placed on the outer sides, the conductive layers, the interface materials and the magnetic assembling body 3a are laminated together at the same time. In the embodiment, the conductive layer 50 on the first interface material 30 is electrically connected to the pin 13a on the bottom surface 102 of the magnetic core 10a through the blind via 51. The conductive layer 60 on the second interface material 40 is electrically connected to the pin 12a on the top surface 101 of the magnetic core 10a through the blind via 61. When the magnetic core 10a produced through the thinning process is further assembled with the peripheral structure 20, the height difference H2 between the pin 12a on the top surface 101 of the magnetic core 10a and the top surface 201 of the peripheral structure 20, and the height difference H2 between the pin 13a on the bottom surface 102 of the magnetic core 10a and the bottom surface 202 of the peripheral structure 20 are less than or equal to 0.08 mm. It helps to maintain the consistency of the subsequent lamination operation of the first interface material 30 and the second interface material 40, reduce the distance from the pins to the conductive layer, and further reduce the defect rate of the blind vias in the subsequent embedded processes. At the same time, the pins of the winding are led out from the top surface and the bottom surfaces of the magnetic core, respectively, so as to reduce the connection path between the magnetic component assembly and the power device. Thus, the connection loss is reduced, and the efficiency is improved. Certainly, in other embodiments, the first interface material 30 and the second interface material 40 are further thinned to reduce the working height of the blind vias through the thinning process, and improve the product yield.

From the above, when the height of the peripheral structure 20 is greater than the height of the magnetic component 2a, it helps to prevent the magnetic component 2a from being fractured during the subsequent lamination operation of the interface materials. However, if the height difference between the peripheral structure 20 and the magnetic component 2a is too large, the consistency of the subsequent lamination operation of the interface materials is affected, and the difficulty of making blind vias after the lamination operation is increased. Therefore, by thinning one side of the interface material of the magnetic component assembly 1 or thinning the magnetic core 10a in the manufacturing process of the magnetic component assemblies 1, la, the spaced distance H1 between the pin 12 of the winding 11 on the top surface 101 of the magnetic core 10 and the top thinned P1 and the spaced distance H1 between the pin 13 of the winding 11 on the bottom surface 102 of the magnetic core 10 are controlled to be less than or equal to 0.08 mm. Alternatively, the height difference H2 formed between the top surface 101 of the magnetic core 10a and the top surface 201 of the peripheral structure 20 and the height difference H2 formed between the pin 13a of the winding 11 on the bottom surface 102 of the magnetic core 10a and the bottom surface 202 of the peripheral structure 20 are controlled to be less than or equal to 0.08 mm. The risk of poor electroplating in the other subsequent embedded processes is avoided sufficiently, so that the product yield is improved. In other embodiments, the pins 12, 12a, 13, 13a of the magnetic component 2, 2a are protruded, and cooperated with the thinning process of the second interface material 40 or the first interface material 30 to be exposed. In this way, it allows to omit the blind vias 51, 61 in the above embodiments, so that the DC resistance (DCR) of the magnetic component assembly 1 is optimized.

In summary, the present disclosure provides a magnetic component assembly and a manufacturing method thereof for forming the magnetic component assembly with the embedded magnetic component meeting the requirements miniaturization and mass production manufacturing. The spaced distance between the pins of the windings and thinned plane is controlled by thinning the magnetic assembling body for reducing the impact of dimensional errors, avoiding the risk of poor electroplating in subsequent embedded processes, and further improving the product yield. By thinning the magnetic core or the pins of the windings to minimize the tolerances of the magnetic core or the pins of the windings, the height difference between the pins of the windings and the peripheral structure is controlled to reduce the risk of poor electroplating in the other subsequent embedded processes. Thus, the product yield is improved. By leading out the pins of the winding through the upper and lower surfaces of the magnetic core, the connection path between the magnetic component and the power device is reduced, so that the connection loss is reduced, and the efficiency is improved. At the same time, the magnetic component allows integrate the signal pins and the power pins to improve the production efficiency.

It should be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method of a magnetic component assembly, comprising steps of:
(a) providing a peripheral structure;
(b) providing a magnetic component, and assembling the magnetic component with the peripheral structure to form a magnetic assembling body, wherein the magnetic component comprises a magnetic core and a winding, and the winding is embedded in the magnetic core and extended to the top surface or the bottom surface of the magnetic core to form a pin, wherein the peripheral structure is disposed adjacent to a peripheral side of the magnetic core;
(c) laminating the magnetic assembling body; and
(d) thinning the top surface of the magnetic assembling body to form a top thinned plane of the magnetic assembling body through a thinning process, or, thinning the bottom surface of the magnetic assembling body to form a bottom thinned plane of the magnetic assembling body through another thinning process.

2. The manufacturing method of the magnetic component assembly according to claim 1, wherein the step (b) further comprises providing a first interface material, wherein the bottom surface the magnetic assembling body is disposed on the first interface material, wherein the bottom surface of the peripheral structure and the bottom surface of the magnetic core are coplanar on the first interface material, wherein the first interface material is laminated with the magnetic assembling body in the step (c), wherein the first interface material or both of the first interface material and the bottom surface of the magnetic assembling body are thinned through the thinning process to form the bottom thinned plane in the step (d), wherein the manufacturing method further comprises a step of: (e) forming a conductive layer on the bottom thinned plane, wherein the conductive layer is electrically connected to the pin on the bottom surface of the magnetic core through a blind via.

3. The manufacturing method of the magnetic component assembly according to claim 2, wherein the top surface of the peripheral structure is higher than the top surface of the magnetic core, and the peripheral structure is a frame or a plastic encapsulated structure formed by molding.

4. The manufacturing method of the magnetic component assembly according to claim 1, wherein a spaced distance formed between the bottom thinned plane and the pin on the bottom surface of the magnetic core is less than or equal to 0.08 mm, or, a spaced distance formed between the top thinned plane and the pin on the top surface of the magnetic core is less than or equal to 0.08 mm.

5. The manufacturing method of the magnetic component assembly according to claim 2, wherein the step (b) further comprises providing a carrying board, wherein the first interface material is disposed on the carrying board.

6. The manufacturing method of the magnetic component assembly according to claim 1, wherein the step (b) further comprises providing a second interface material, wherein the top surface the magnetic assembling body is disposed on the second interface material, wherein the second interface material is laminated with the magnetic assembling body in the step (c), wherein the second interface material or both of the second interface material and the top surface of the magnetic assembling body are thinned through the thinning process to form the top thinned plane in the step (d), wherein the manufacturing method further comprises a step of: (e) forming a conductive layer on the top thinned plane, wherein the conductive layer is electrically connected to the pin on the top surface of the magnetic core through a blind via.

7. The manufacturing method of the magnetic component assembly according to claim 2, further comprising steps of:
(f) providing a second interface material, wherein the top surface the magnetic assembling body is disposed on the second interface material;
(g) laminating the second interface material with the magnetic assembling body;
(h) thinning the second interface material or both of the second interface material and the top surface of the magnetic assembling body are thinned through the thinning process to form the top thinned plane; and
(i) forming a conductive layer on the top thinned plane, wherein the conductive layer is electrically connected to the pin on the top surface of the magnetic core through a blind via.

8. The manufacturing method of the magnetic component assembly according to claim 7, wherein the first interface material or the second interface material is an insulating material.

9. The manufacturing method of the magnetic component assembly according to claim 1, wherein the pin is protruded from the top surface or the bottom surface of the magnetic core to be exposed.

10. The manufacturing method of the magnetic component assembly according to claim 1, wherein the pin is protruded from the bottom surface of the magnetic core to be exposed through the bottom thinned plane, or, the pin is protruded from the top surface of the magnetic core to be exposed through the top thinned plane.

11. The manufacturing method of the magnetic component assembly according to claim 1, wherein the thinning process is a grinding process or a plasma thinning process.

12. A manufacturing method of a magnetic component assembly, comprising steps of:
(a) providing a magnetic component, wherein the magnetic component wherein the magnetic component comprises a magnetic core and a winding, and the winding is embedded in the magnetic core and extended to the top surface or the bottom surface of the magnetic core to form a pin;
(b) thinning the top surface or the bottom surface of the magnetic core through a thinning process, or thinning the pin through another thinning process;
(c) providing a peripheral structure; and
(d) combining the magnetic component and the peripheral structure to form a magnetic assembling body, wherein the peripheral structure is disposed adjacent to a peripheral side of the magnetic core.

13. The manufacturing method of the magnetic component assembly according to claim 12, wherein the step (d) further comprises providing a carrying board, wherein the bottom surface of the magnetic assembling body is disposed on the carrying board, the bottom surface of the peripheral structure and the bottom surface of the magnetic core are coplanar on the carrying board in the step (d), and the top surface of the peripheral structure and the pin on the top surface of the magnetic core have a height difference less than or equal to 0.08 mm, wherein the carrying board is connected to the bottom surface of the magnetic assembling body through an insulating layer.

14. The manufacturing method of the magnetic component assembly according to claim 13, further comprising a step of: (e) laminating a second interface material on the top surface of the magnetic assembling body.

15. The manufacturing method of the magnetic component assembly according to claim 14, further comprising steps of:
(f) removing the carrying board; and
(g) laminating a first interface material on the bottom surface of the magnetic assembling body, wherein the first interface material or the second interface material is an insulating material.

16. The manufacturing method of the magnetic component assembly according to claim 15, further comprising steps of:
(h) forming a blind via in the first interface material or the second interface material, wherein the blind via is spatially corresponding to the pin on the top surface or the bottom surface of the magnetic core; and
(i) forming a conductive layer on the bottom side of the first interface material or the top side of the second interface material, wherein the conductive layer is electrically connected to the pin on the top surface or the bottom surface of the magnetic core through the blind via.

17. The manufacturing method of the magnetic component assembly according to claim 12, wherein the top surface of the peripheral structure is higher than the top surface of the magnetic core, and the peripheral structure is a frame or a plastic encapsulated structure formed by molding.

18. The manufacturing method of the magnetic component assembly according to claim 12, wherein the thinning process is a grinding process or a plasma thinning process.

19. A magnetic component assembly comprising:
a magnetic component comprising a magnetic core and a winding, wherein the winding is embedded in the magnetic core, and passing through the top surface or the bottom surface of the magnetic core to form a pin; and
a peripheral structure disposed adjacent to a peripheral side of the magnetic core.

20. The magnetic component assembly according to claim 19, wherein the pin is protruded from the top surface or the bottom surface of the magnetic core to be exposed.

21. The magnetic component assembly according to claim 19, wherein the bottom surface of the peripheral structure and the bottom surface of the magnetic core are coplanar, and a height difference formed between the top thinned plane and the pin on the top surface of the magnetic core is less than or equal to 0.08 mm, and the peripheral structure is a frame or a plastic encapsulated structure formed by molding.

22. The magnetic component assembly according to claim 21, wherein the top surface or the bottom surface of the magnetic core is produced through a thinning process, and the thinning process is a grinding process or a plasma thinning process.

23. The magnetic component assembly according to claim 19, further comprising a first interface material, wherein the bottom surface of the peripheral structure and the bottom surface of the magnetic core are disposed on the first interface material, and the magnetic component assembly further comprises a conductive layer disposed on the bottom surface of the first interface material, wherein the conductive layer is electrically connected to the pin on the bottom surface of the magnetic core through a blind via, wherein the first interface material is an insulating material.

24. The magnetic component assembly according to claim 23, further comprising a second interface material, wherein the second interface material is laminated on the top surface of the peripheral structure and the top surface of the magnetic core, and a conductive layer is disposed on the top surface of second interface material, wherein the conductive layer is electrically connected to the pin on the top surface of the magnetic core through a blind via, wherein the second interface material is an insulating material.

25. The magnetic component assembly according to claim 24, wherein the top surface of the second interface material is thinned through a thinning process to form a top thinned plane of the magnetic component, and the top thinned plane is higher than the top surface of the magnetic core, and a spaced distance formed between the top thinned plane and the pin on the top surface of the magnetic core is less than or equal to 0.08 mm, wherein the magnetic component assembly further comprises a conductive layer, and the conductive layer formed on the top thinned plane is electrically connected to the pin on the top surface of the magnetic core through a blind via, or the bottom surface of the first interface material is thinned through the thinning process to form a bottom thinned plane of the magnetic component, and the bottom thinned plane is lower than the bottom surface of the magnetic core, and a spaced distance formed between the bottom thinned plane and the pin on the bottom surface of the magnetic core is less than or equal to 0.08 mm, wherein the magnetic component assembly further comprises a conductive layer, and the conductive layer formed on the bottom thinned plane is electrically connected to the pin on the bottom surface of the magnetic core through a blind via.

26. The magnetic component assembly according to claim 24, wherein the top surface of the peripheral structure is higher than the top surface of the magnetic core, the top surface of the peripheral structure and the second interface material are thinned through a thinning process to form a top thinned plane of the magnetic component, and the top thinned plane is higher than the top surface of the magnetic core, and a spaced distance formed between the top thinned plane and the pin on the top surface of the magnetic core is less than or equal to 0.08 mm, wherein the magnetic component assembly further comprises a conductive layer, and the conductive layer formed on the top thinned plane is electrically connected to the pin on the top surface of the magnetic core through a blind via, or the bottom surface of the peripheral structure is lower than the bottom surface of the magnetic core, the bottom surface of the peripheral structure and the first interface material are thinned through the thinning process to form a bottom thinned plane of the magnetic component, and a spaced distance formed between the bottom thinned plane and the pin on the bottom surface of the magnetic core is less than or equal to 0.08 mm, wherein the magnetic component assembly further comprises a conductive layer, and the conductive layer formed on the bottom thinned plane is electrically connected to the pin on the bottom surface of the magnetic core through a blind via.

27. The magnetic component assembly according to claim 23, wherein the top surface of the pin on the top surface of the magnetic core or the bottom surface of the pin on the bottom surface of the magnetic core is produced through a thinning process, and the thinning process is a grinding process or a plasma thinning process.
